(19) United States
(12) Patent Application Publication
(10) Pub. No.: US 2013/0215345 A1
(43) Pub. Date: Aug. 22, 2013

(54) COLOR LIQUID CRYSTAL DISPLAY DEVICE

(71) Applicants: Seiji Kaneko, Osaka (JP); Yasuyuki Ogawa, Osaka (JP)

(72) Inventors: Seiji Kaneko, Osaka (JP); Yasuyuki Ogawa, Osaka (JP)

(73) Assignee: SHARP KABUSHIKI KAISHA, Osaka (JP)

(21) Appl. No.: 13/881,109

(22) PCT Filed: Oct. 20, 2011
(86) PCT No.: PCT/JP2011/005880

§ 371 Date: Apr. 23, 2013

(30) Foreign Application Priority Data
Oct. 27, 2010 (JP) 2010-240828

(51) Int. Cl. G02F 1/1343

(52) U.S. Cl. CPC G02F 1/134309
USPC 349/41

(57) ABSTRACT

The sum of parasitic capacitances C_{G} and C_{B}, which are formed between each of two source signal lines 25SL_{G} and 25SL_{B} that constitute any of a first color to a third color pixel, and a pixel electrode 27_{G} corresponding to the pixel, is set so as to be smaller in the first color pixel than in other color pixels.

### TECHNICAL FIELD

The present invention relates to a color liquid crystal display device, and in particular relates to a low power consumption color liquid crystal display device in which a panel that can be driven at low frequency is used and in which the occurrence of flickering display brightness is mitigated.

### BACKGROUND ART

In recent years, there is increased demand for less energy consumption for display panels used as displays for electronic book devices, mobile telephones, and the like.

Methods for reducing power consumption in a display panel include increasing the aperture ratio of a panel in order to attain excellent brightness or driving the panel at low frequency.

One method for increasing the aperture ratio of a panel is to dispose a pixel electrode provided for each pixel to overlap with a source signal line, for example. According to this configuration, by removing the region between the pixel electrode and the source signal line, it is possible to reduce the amount of area not related to the pixel area, and thereby increase the aperture ratio (Patent Document 1, for example).

### RELATED ART DOCUMENTS

### Patent Documents

Patent Document 1: Japanese Patent Application Laid-Open Publication No. 2001-228491

### SUMMARY OF THE INVENTION

### Problems to be Solved by the Invention

However, by disposing the pixel electrode to overlap with the source signal line, a parasitic capacitance is generated between the pixel electrode and the source signal line. If a parasitic capacitance is generated between the pixel electrode and the source signal line, the electric potential applied to the pixel electrode changes along with changes in the electric potential applied to the source signal line. If low frequency driving is additionally conducted for reducing power consumption, the above-mentioned change in electric potential for the pixel electrode results in marked flickering in the display pixels. In particular, flickering in pixels of colors with high luminosity becomes noticeably unpleasant to the user when viewing the display panel as a whole. As a result, measures to prevent flickering in pixels with high luminosity, such as green pixels, are sought after.

An object of the present invention is to mitigate flickering in pixels of colors with high luminosity in order to attain excellent display quality for the entire color liquid crystal display device.

### Means for Solving the Problems

A color liquid crystal display device of the present invention includes an active matrix substrate and an opposite substrate disposed opposite to each other with a liquid crystal layer therebetween, wherein the active matrix substrate includes: a plurality of gate signal lines that extend parallel to each other in a display region; a plurality of storage capacitance wiring lines provided in a same layer as the gate signal lines and between the gate signal lines, extending parallel to the gate signal lines and to each other; a gate insulating film provided so as to cover the plurality of gate signal lines and the plurality of storage capacitance wiring lines; a plurality of source signal lines provided in a layer above the gate insulating film and intersecting orthogonally with the plurality of gate signal lines while extending parallel to each other; an interlayer insulating film provided so as to cover the source signal lines; a plurality of pixels each formed in a region bordered by the plurality of gate signal lines and source signal lines; a plurality of switching elements provided so as to respectively correspond to the plurality of pixels and provided for respective intersections of the plurality of gate signal lines and source signal lines; and a plurality of pixel electrodes provided in a layer above the interlayer insulating film respectively corresponding to the plurality of pixels, wherein the plurality of pixels include at least a first color pixel that conducts display in a first color, a second color pixel that conducts display in a second color having a lower standard luminosity than the first color, and a third color pixel that conducts display in a third color having a lower standard luminosity than the first color, and wherein a sum of parasitic capacitances formed between the pixel electrode and respective two source signal lines of any of the first to third color pixels is less in the first color pixel than in other pixels.

Where the size of potential change of the pixel electrode due to a change in potential in the source signal line is ΔVₚᵢₓ, the sizes of the parasitic capacitances between the pixel electrode and the two source signal lines of the pixel are respectively C₁ and C₂, the size of potential change of one of the two source signal lines is ΔV, the size of the liquid crystal capacitance is C_{1c}, the size of the parasitic capacitance between the gate and the drain is C_{gd}, and the storage capacitance generated between the storage capacitance wiring line and the pixel electrode is Cs, the relation therebetween is shown in formula 1 below.

$$\begin{matrix}〈 Formula 1 〉 & \\ Δ {V}_{pix} = Δ V \times \frac{{C}_{1}}{{C}_{gd} + Cs + {C}_{lc} + {C}_{1} + {C}_{2}} & ( 1 )\end{matrix}$$

According to the above-mentioned configuration, in the first color pixel with the highest standard luminosity, the sum of the parasitic capacitances C₁ and C₂ generated between the respective two source signal lines of the pixel and the pixel electrode corresponding to that pixel is set smaller than in other pixels, and thus, the size of change ΔVₚᵢₓ, in potential for the pixel electrode is also less than in other pixels, as in formula 1. By having a smaller size of change ΔVₚᵢₓ in potential for high luminosity pixel electrodes, the occurrence of flickering in the first color pixels with a high luminosity is mitigated. Therefore, users who view the panel will not detect as much flickering, and as a result, it is possible to attain excellent display quality for the entire color liquid crystal display device.

In the color liquid crystal display device of the present invention, it is preferable that a storage capacitance formed between a storage capacitance wiring line disposed in each of the first to third color pixels and a pixel electrode corresponding to the pixel be set greater in the first color pixel than in other pixels.

According to the above-mentioned configuration, in the first color pixel with the highest standard luminosity, the storage capacitance Cs of the first color pixel is set greater than in other pixels, and the size of change ΔVₚᵢₓ in potential in the pixel electrode is less than in other pixels, as in formula 1. By having a smaller size of change ΔVₚᵢₓ in potential for high luminosity pixel electrodes, the occurrence of flickering in the first color pixels with a high luminosity is mitigated. Therefore, users who view the panel will not detect as much flickering, and as a result, it is possible to attain excellent display quality for the entire color liquid crystal display device.

The color liquid crystal display device of the present invention conducts RGB color display, wherein the first color pixel is a green pixel that conducts display in green, the second color pixel is a red pixel that conducts display in red, and the third color pixel is a blue pixel that conducts display in blue, for example.

In the color liquid crystal display device of the present invention, it is preferable that in the green pixel, the respective two source signal lines of the green pixel do not overlap with the pixel electrode corresponding to the green pixel from a plan view.

According to the above-mentioned configuration, in the green pixel, which has the highest luminosity, the two source signal lines of the green pixel and the pixel electrode corresponding to the green pixel are disposed so as not to overlap from a plan view, and thus, parasitic capacitance is not generated between the two source signal lines of the green pixel and the pixel electrode that corresponds to the pixel, and the size of change in potential in the pixel electrode in the green pixel can be reduced to almost 0.

However, from the perspective of ensuring a sufficient aperture ratio, it is also possible to reduce the parasitic capacitance between the source signal lines and the pixel electrode in the green pixel by disposing respective two source signal lines of each green pixel and a pixel electrode corresponding to each green pixel such that the overlapping portion thereof is smaller than in the red pixel and the blue pixel from a plan view.

A pixel electrode corresponding to the red pixel may overlap with a source signal line that supplies a source signal to a switching element corresponding to the green pixel from a plan view.

Alternatively, a pixel electrode corresponding to the blue pixel may overlap with a source signal line that supplies a source signal to a switching element corresponding to the green pixel from a plan view.

According to the above-mentioned configuration, the pixel electrode corresponding to the red pixel or the blue pixel is provided to overlap from a plan view with a source signal line that supplies a source signal to the switching element corresponding to the green pixel, and thus, it is possible to increase the aperture ratio of the red pixel or the blue pixel compared to a case in which these elements do not overlap.

In the color liquid crystal display device of the present invention, a distance between the two source signal lines of the green pixel may be greater than in other pixels such that a storage capacitance formed between a storage capacitance wiring line disposed in each of the plurality of pixels and a pixel electrode corresponding to the pixel may be set to be greater in the green pixel than in other pixels.

Alternatively, the gate insulating film may be thinner in a region of the green pixel than in other pixel regions such that a storage capacitance formed between a storage capacitance wiring line disposed in each of the plurality of pixels and a pixel electrode corresponding to the pixel may be set to be greater in the green pixel than in other pixels.

In the color liquid crystal display device of the present invention, it is preferable that on the opposite substrate, a plurality of color filters be provided so as to respectively correspond to the plurality of pixels, and a black matrix be provided corresponding to regions bordering the plurality of pixels so as to border the plurality of color filters.

In the color liquid crystal display device of the present invention, the plurality of pixels may further include a fourth color pixel that conducts display in a fourth color with a lower standard luminosity than the first color, in addition to the first to third color pixels.

In this case, the first color is green, the second color is red, the third color is blue, and the fourth color is yellow, for example.

The color liquid crystal display device of the present invention can attain an excellent display quality by mitigating flickering in high luminosity pixels, and thus, can be suitably used when pixel data rewriting is conducted at a low frequency of 45 Hz or less.

With the color liquid crystal display device of the present invention, flickering in high luminosity pixels is mitigated, and thus, users who view the panel do not readily detect flickering, and therefore, even when conducting low energy consumption driving or still image display, the color liquid crystal display device can be suitably used for a display of an electronic book or the like in which high display quality is sought.

### Effects of the Invention

According to the present invention, the sum of the parasitic capacitances generated respectively between the two source signal lines of each pixel of the first to third color pixels and the pixel electrode corresponding to the pixel is set lower in the first color pixel with the highest standard luminosity than in other pixels, and thus, the size of potential change in the pixel electrode due to changes in the voltage of the source signal line is less than for other pixels, and thus, flickering in the first color pixel is mitigated. Therefore, by mitigating flickering in high luminosity pixels, the user who views the panel does not readily detect flickering, and an excellent display quality can be attained for the entire color liquid crystal display device.

### BRIEF DESCRIPTION OF THE DRAWINGS

FIG. 1 is a schematic plan view of a color liquid crystal display device of Embodiment 1.

FIG. 2 is a cross-sectional view of FIG. 1 along the line II-II.

FIG. 3 is a plan view of a TFT substrate according to Embodiment 1.

FIG. 4 is a cross-sectional view of FIG. 3 along the line IV-IV.

FIG. 5 is a cross-sectional view of FIG. 3 along the line V-V.

FIG. 6 is a cross-sectional view of a portion corresponding to the line IV-IV of FIG. 3 in the color liquid crystal display device of Embodiment 1.

FIG. 7 is a circuit diagram that shows an equivalent circuit of a TFT substrate.

FIG. 8 is a graph that shows a standard luminosity curve.

FIG. 9(a) is a graph that shows a change in brightness of a panel surface over time in a conventional color liquid crystal display device, and FIG. 9(b) is a graph that shows a change in brightness of a panel surface over time in the color liquid crystal display device of Embodiment 1.

FIG. 10 is a plan view of a TFT substrate according to a Modification Example 1 of Embodiment 1.

FIG. 11 is a plan view of a TFT substrate according to a Modification Example 2 of Embodiment 1.

FIG. 12 is a plan view of a TFT substrate according to Embodiment 2.

FIG. 13 is a plan view of a TFT substrate according to Embodiment 3.

FIG. 14 is a cross-sectional view of FIG. 13 along the line XIV-XIV.

### DETAILED DESCRIPTION OF EMBODIMENTS

Embodiments of the present invention will be described in detail below with reference to drawings. The present invention is not limited to the embodiments below.

### Embodiment 1

### <Liquid Crystal Display Device>

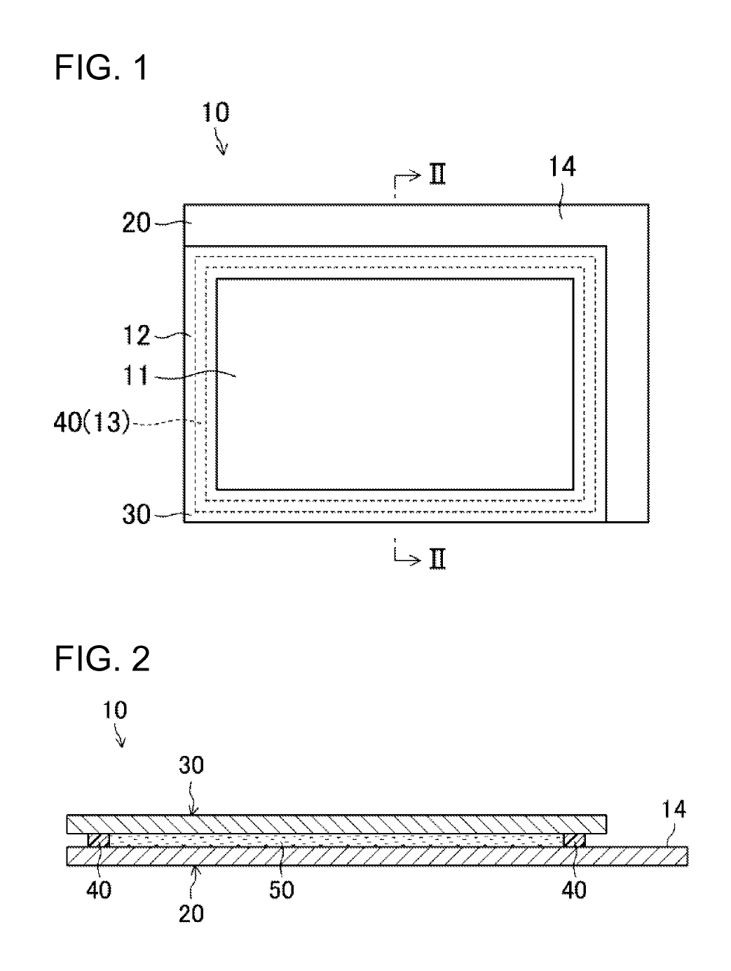

FIG. 1 is a plan view that shows an external view of main parts of a color liquid crystal display device 10 according to Embodiment 1. FIG. 2 is a cross-sectional view that includes a cross-section of FIG. 1 along the line II-II and shows configuration of main parts of the color liquid crystal display device 10.

The color liquid crystal display device 10 has a liquid crystal display panel, and a backlight unit (not shown in drawings), which is an illumination device disposed facing the liquid crystal display panel.

In the liquid crystal display panel, as shown in FIGS. 1 and 2, a TFT substrate 20, which is an active matrix substrate, is disposed opposite to an opposite substrate 30. A sealing member 40 is provided in a frame shape in a periphery between the substrates 20 and 30, thus bonding the substrates 20 and 30 together. A liquid crystal layer 50 is provided in the region of the substrates 20 and 30 surrounded by the sealing member 40.

In the color liquid crystal display device 10, an inner side of a sealed region 13, which is a frame shaped region provided with the sealing member 40, is a display region 11 that displays images. In the display region 11, a plurality of pixels (not shown in drawings) are arranged in a matrix. The frame-shaped region that is outside of the display region 11 and includes the sealed region 13 is a non-display region 12 that does not display images. In the non-display region 12, a plurality of terminals (not shown in drawings) are formed and constitute a terminal region 14 in which a driver chip (not shown in drawings) for driving the liquid crystal display panel is mounted.

The plurality of pixels include green pixels that display green, red pixels that display red, and blue pixels that display blue, and a large number of these pixels are disposed with a prescribed layout. The green pixels can display green by green color filters provided in respective regions of the opposite substrate 30 corresponding to the green pixels. Similarly, the red pixels and the blue pixels can display red and blue, respectively, by red and blue color filters respectively provided in the regions of the opposite substrate 30 corresponding to the respective pixels. The green pixel, the red pixel, and the blue pixel constitute one pixel unit, which allows a desired color to be displayed.

### (TFT Substrate)

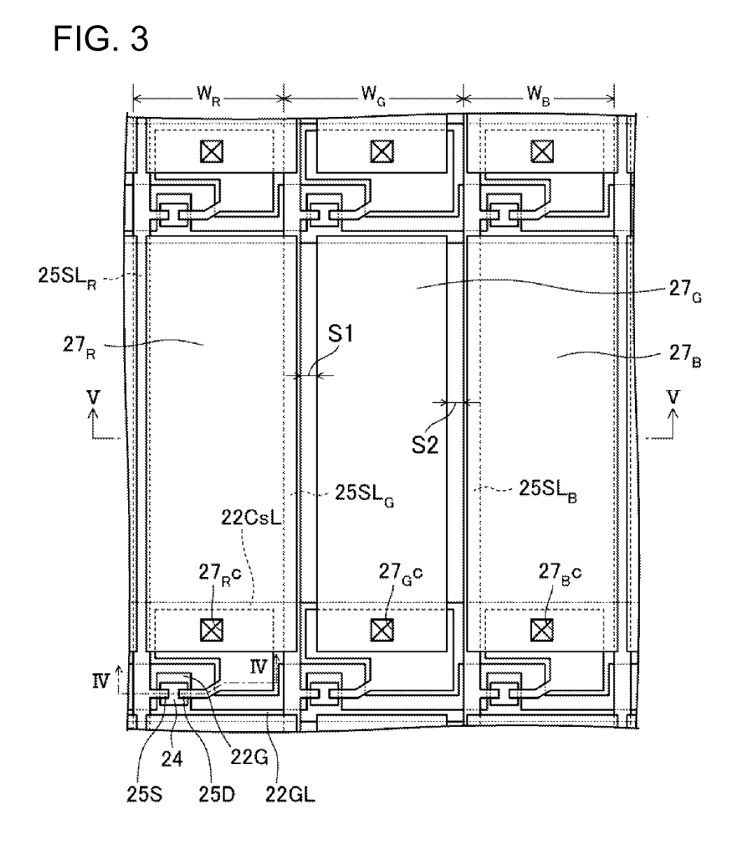

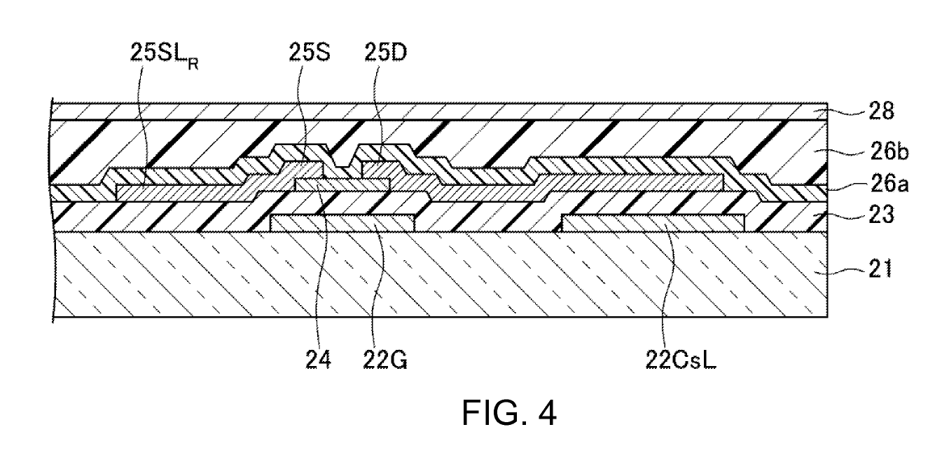

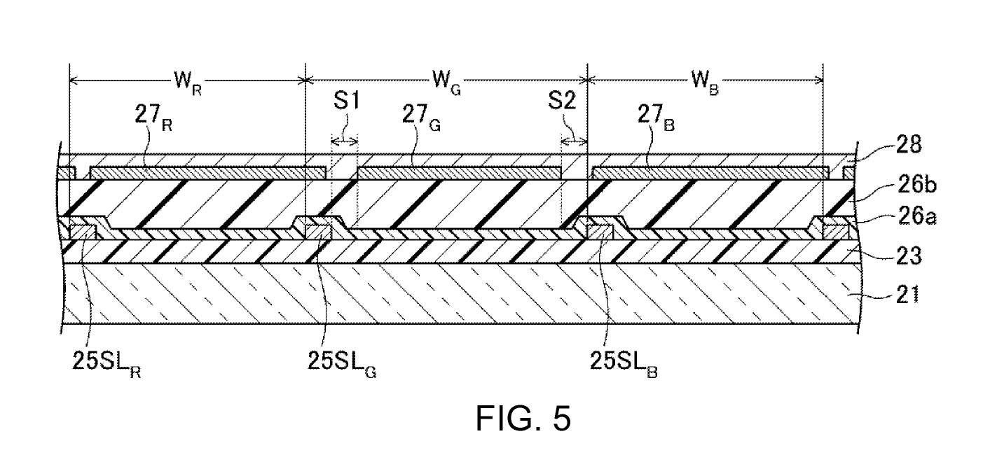

FIG. 3 is a portion of a plan view of the display region 11 of the TFT substrate 20. FIG. 4 is a cross-sectional view of FIG. 3 along the line IV-IV. FIG. 5 is a cross-sectional view of FIG. 3 along the line V-V.

The TFT substrate 20 has a configuration in which various signal lines and the like that include a gate signal line 22GL, a gate insulating film 23, a semiconductor film 24, various signal lines and the like that include source signal lines 25SL_{R}, 25SL_{G}, and 25SL_{B}, an overcoat film 26a and a planarizing film 26b that constitute an interlayer insulating film, pixel electrodes 27_{R}, 27_{G}, and 27_{B}, and an alignment film 28 are layered in this order on a main substrate body 21.

Reference characters with the subscripts “_{R}”, “_{G}”, and “_{B}” of the source signal lines 25SL_{R}, 25SL_{G}, and 25SL_{B} and the pixel electrodes 27_{R}, 27_{G}, and 27_{B} signify that such reference characters correspond respectively to the red pixel, the green pixel, and the blue pixel. Also, in the description below, in some cases, the “source signal lines 25SL_{R}, 25SL_{G}, and 25SL_{B}” will be abbreviated as the “source signal lines 25SL”. The same is true for the “pixel electrodes 27”, the “color filters 32”, and the like.

Also, in each drawing, the configurations with a 22 in the reference character such as 22GL and 22G are all made of the same material as the gate signal line 22GL. The configurations with a 25 in the reference character such as 25SL and 25S are all made of the same material as the source signal line 25SL.

The main substrate body 21 is constituted of a glass substrate or the like, for example.

The various signal lines and the like that include the gate signal lines 22GL are constituted of gate signal lines 22GL, storage capacitance wiring lines 22CsL, gate electrodes 22G, and the like. The conductive film that constitutes these wiring lines and electrodes is made of a simple element such as AL, Cu, Mo, Ti, W, Cr, and Nd, or an alloy or compound constituted of these elements as main components, for example. The conductive film may be a single layer film or a multilayer film.

The gate signal lines 22GL are disposed such that the plurality thereof extend parallel to each other. The gate signal lines 22GL have a function of supplying a control signal to the TFTs.

The storage capacitance wiring lines 22CsL are provided between two gate signal lines 22GL so as to extend parallel thereto. The storage capacitance wiring lines 22CsL are wiring lines for applying a prescribed voltage to a storage capacitance formed in each pixel.

The regions of the gate signal lines 22GL corresponding to the TFTs are formed to be the gate electrodes 22G.

The gate insulating film 23 is made of an inorganic insulating film such as a silicon oxide film (SiO_{X} film) or a silicon nitride film (SiN_{X} film) or a multilayer film thereof, for example.

The semiconductor film 24 is made by layering an intrinsic amorphous silicon film and an n⁺ amorphous silicon film, for example. The semiconductor film 24 may be made of an oxide semiconductor such as indium gallium zinc oxide, or an oxide semiconductor such as zinc oxide (ZiO), zinc tin oxide (ZTO), strontium titanium dioxide (SrTiO₂), indium oxide (In₂O₃), and copper aluminum oxide (CuAlO₂), for example, instead of the amorphous silicon.

Various signal lines and the like that include the source signal lines 25SL are constituted of the source signal lines 25SL, the source electrodes 25S, the drain electrodes 25D, lead-out wiring that is not shown in the drawings, inspection wiring lines, and the like. The conductive film that constitutes these wiring lines and electrodes is made of a simple element such as AL, Cu, Mo, Ti, W, Cr, and Nd, or an alloy or compound constituted of these elements as main components, for example. The conductive film may be a single layer film or a multilayer film.

A plurality of source signal lines 25SL are disposed to extend parallel to each other, and to respectively intersect orthogonally with the gate signal lines 22GL. The source signal lines 25SL have a function of supplying a data signal (source signal) to the TFTs. The source signal lines 25SL are constituted of the source signal lines 25SL_{R} for the red pixels that apply a source signal to red pixel TFTs, the source signal lines 25SL_{G} for the green pixels that apply a source signal to green pixel TFTs, and the source signal lines 25SL_{B} for the blue pixels that apply a source signal to blue pixel TFTs. Properties of the layout of each source signal line 25SL_{R}, 25SL_{G}, and 25SL_{B} will be described below.

As shown in FIG. 3, the source electrode 25S and the drain electrode 25D are disposed opposite to each other in a layer above the gate electrode 22G.

The overcoat film 26a and the planarizing film 26b are layered in that order in layers above the gate insulating film 23, the source signal lines 25SL, and the like. The overcoat film 26a and the planarizing film 26b are made of a silicon oxide film (SiOₓ film) or a silicon nitride film (SiNₓ film), for example. As shown in FIG. 3, contact holes 27c (27_{R}c, 27_{G}c, 27_{B}c) that reach the drain electrodes 25D are formed in the overcoat film 26a and the planarizing film 26b.

The pixel electrode 27 is provided for each pixel in the display region. The pixel electrode 27 is made of a transparent conductive film such as ITO (indium tin oxide) or IZO (indium zinc oxide), for example. The pixel electrodes 27 are provided so as to cover the surface of the contact holes 27c provided in the overcoat film 26a and the planarizing film 26b, and thus are electrically connected to the drain electrodes 25D.

The pixel electrode 27_{G} provided in the green pixel is disposed so as not to overlap with the two source signal lines 25SL_{G} and 25SL_{B} of the green pixel from a plan view.

Specifically, the value of S1 shown in FIG. 3 is set to be positive. As a result, parasitic capacitance is not generated between the pixel electrode 27_{G} and the source signal line 25SL_{G}, and it is thus possible to mitigate changes in potential applied to the pixel electrode 27_{G} due to changes in potential of the source signal supplied to the TFT of the green pixel by the source signal line 25SL_{G}.

Also, the value of S2 shown in FIG. 3 is set to be positive. As a result, parasitic capacitance is not generated between the pixel electrode 27_{G} and the source signal line 25SL_{B}, and it is thus possible to mitigate changes in potential applied to the pixel electrode 27_{G} due to changes in potential of the source signal supplied to the TFT of the blue pixel by the source signal line 25SL_{B}.

Although it was stated that the two source signal lines 25SL_{G} and 25SL_{B} and the pixel electrode 27_{G} are disposed so as not to overlap and such that the values of S1 and S2 are positive, the elements may be disposed such that S1 and S2 are 0.

The pixel electrode 27_{R} provided in the red pixel is disposed to overlap in part from a plan view with the source signal line 25SL_{R} that inputs a source signal to the TFT of the red pixel and the source signal line 25SL_{G} that inputs a source signal to the TFT of the green pixel. With this configuration, it is possible to have the aperture ratio of the red pixel be equal to or greater than when the pixel electrode 27_{R} and the source signal lines SL_{R} and SL_{G} do not overlap.

While the green pixel source signal line 25SL_{G} does not overlap with the pixel electrode 27_{G} of the green pixel, the pixel electrode 27_{R} of the red pixel is disposed to overlap with the source signal line 25SL_{G} of the green pixel, and thus, a parasitic capacitance is formed between the source signal line 25SL_{G} of the green pixel and the pixel electrode 27_{R} of the red pixel. As a result, the change in potential applied to the source signal line 25SL_{G} of the green pixel causes a change in the potential for the pixel electrode 27_{R} of the red pixel and not the pixel electrode 27_{G} of the green pixel. Therefore, flickering in the green pixels due to changes in potential in the source signal lines 25SL_{G} of the green pixels is mitigated.

The pixel electrode 27_{B} provided in the blue pixel is disposed so as to overlap in part from a plan view with the source signal line 25SL_{B} that inputs a source signal to the blue pixel TFT and the source signal line 25SL_{B} that inputs a source signal to the red pixel TFT. With this configuration, it is possible to have the aperture ratio of the blue pixel be equal to or greater than when the pixel electrode 27_{B} and the source signal lines SL_{B} and SL_{R} do not overlap.

The alignment film 28 is made of a polyimide film or the like.

On the main substrate body 21, as shown in FIGS. 3 and 4, a TFT is formed for each pixel at a position where the gate signal line 22GL and the source signal line 22SL intersect. The TFT is a bottom gate type, for example, and is constituted of the gate electrode 22G, the gate insulating film 23, a semiconductor film 24 formed on a surface of the gate insulating film 23, and a source electrode 25S and a drain electrode 25D, which are formed in a layer thereabove. The TFT is controlled to be on or off by being fed a control signal to the gate electrode 22G from the gate signal line 22GL, and by being fed a data signal (source signal) to the source electrode 25S from the source signal line 25SL, a desired potential can be applied to the pixel electrode 27 electrically connected to the drain electrode 25D.

The TFTs provided for the respective pixels match their maximum opposite potential such that the data writing time is equal for the respective pixels. Specifically, the TFT layout is set such that the calculated value of formula 2 below is the same for all TFTs.

$$\begin{matrix}〈 Formula 2 〉 & \\ \frac{{C}_{gd}}{{C}_{gd} + {C}_{lc} + Cs + {C}_{1} + {C}_{2}} & ( 2 )\end{matrix}$$

As shown in FIGS. 3 and 4, a storage capacitance wiring line 22CsL, a gate insulating film 23, and a drain electrode 25D are layered together on the main substrate body 21, and a storage capacitance Cs is generated between the storage capacitance wiring line 22CsL and the drain electrode 25D. By generating a storage capacitance Cs between the storage capacitance wiring line 22CsL and the drain electrode 25D, it is possible to mitigate changes in electric potential in the pixel electrode 27 due to parasitic capacitance or an off leak current in the TFT.

The respective source signal lines 25SL_{R}, 25SL_{G}, and 25SL_{B} are disposed such that a distance W_{G} between the source signal lines 25SL_{G} and 25SL_{B} is greater than a distance W_{R} between the source signal lines 25SL_{R} and 25SL_{G}, and a distance W_{B} between the source signal lines 25SL_{B} and 25SL_{R}. With this configuration, it is possible to make the overlapping area of the storage capacitance wiring line 22CsL and the drain electrode 25D larger in the green pixel from a plan view, and thus, it is possible to set the storage capacitance Cs_{G} generated in the green pixel to be greater than the storage capacitances Cs_{R} and Cs_{B} of the red pixel and the blue pixel.

### (Opposite Substrate)

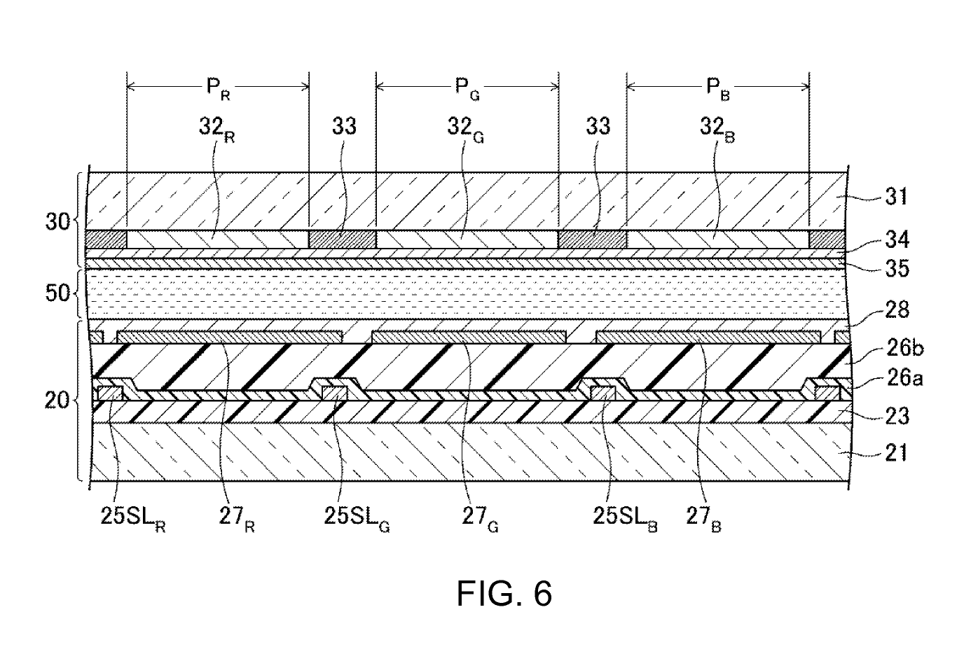

As shown in the cross-sectional view of the liquid crystal display panel in FIG. 6, the opposite substrate 30 has a configuration in which color filters 32 and a black matrix 33 are provided on the main substrate body 31, and an opposite electrode 34 and an alignment film 35 are layered to cover the color filters 32 and the black matrix 33.

The main substrate body 31 is constituted of a glass substrate or the like, for example.

The color filter 32 is provided for each of the plurality of pixels. Types of color filters 32 include a red color filter 32_{R} for the red pixel, a green color filter 32_{G} for the green pixel, and a blue color filter 32_{B} for the blue pixel.

The black matrix 33 is provided in the boundary of the pixels outside of the pixel area so as to partition the color filters 32. Specifically, the black matrix 33 is provided in regions corresponding to where the gate signal lines 22GL, the source signal lines 25SL, TFTs, and the like are provided. In FIG. 6, the black matrix 33 is provided in the same layer as the color filters 32, but the black matrix 33 may be provided in a layer above the color filters 32.

The region of the color filters 32 not covered by the black matrix 33 is the pixel area, which is where the colors of the pixels are seen when displaying images in the panel. Thus, it is preferable that the regions P_{R}, P_{G}, and P_{B} of the color filters 32, which are the pixel areas, have the same area for each pixel. With this configuration, it is possible to maintain color balance between each color in the panel display.

The opposite electrode 34 is provided to cover the color filters 32 and the black matrix 33. The opposite electrode 34 is made of a transparent conductive film such as ITO or IZO, for example. The opposite electrode 34 is supplied with a common potential from common potential wiring lines provided in the terminal region 14 of the TFT substrate 20 through a transfer pad, for example.

The alignment film 35 is made of a polyimide film or the like, for example.

### (Sealing Member 40)

The sealing member 40 is made of an ultraviolet-curable epoxy resin or the like, for example.

### (Liquid Crystal Layer 50)

The liquid crystal layer 50 is constituted of a nematic liquid crystal or the like, for example.

In the color liquid crystal display device 10 with the configuration above, the orientation direction of the liquid crystal in the liquid crystal layer 50 is controlled for each pixel by turning the TFTs on and off, and as a result, the transmittance of light from the backlight is controlled for each pixel. Transmittance of light from the backlight is controlled for each red pixel, green pixel, and blue pixel, and by conducting display per pixel unit at a desired intensity and display color, it is possible to display a desired image in the liquid crystal display panel.

### (Manufacturing Method for Color Liquid Crystal Display Device)

Next, a method for manufacturing a color liquid crystal display device 10 is described. The liquid crystal display device of the present embodiment can be manufactured by using a conventional and well-known manufacturing method for a liquid crystal display device. The color liquid crystal display device 10 is manufactured by bonding together a TFT substrate 20 and an opposite substrate 30, which are prepared separately, through a sealing member 40.

The sealing member 40 is drawn in a rectangular frame shape on the opposite substrate 30, for example, and liquid crystal is dripped into the area inside the frame formed by the sealing member 40. Next, the opposite substrate 30 is positionally aligned with the TFT substrate 20 and the two substrates are bonded together. Then, the sealing member 40 is cured by radiating ultraviolet light to the sealing member 40, thus manufacturing the color liquid crystal display device 10.

Alternatively, the sealing member 40 may be drawn onto the TFT substrate 20 instead of the opposite substrate 30.

The liquid crystal layer 50 may be formed by forming an injection hole (not shown in drawing) in the frame shaped sealing member, conducting a dipping type vacuum injection, and sealing the injection hole shut, instead of using the drip method for injecting the liquid crystal.

### (Effects of Embodiment 1)

In the color liquid crystal display device of the configuration of Embodiment 1, in the green pixel, each of the two source signal lines 25SL_{G} and 25SL_{B} of the green pixel is disposed so as not to overlap with the pixel electrode 27_{G} of the green pixel from a plan view, and thus, parasitic capacitance is not generated between the source signal line 25SL_{G} or 25SL_{B}, and the pixel electrode 27_{G}.

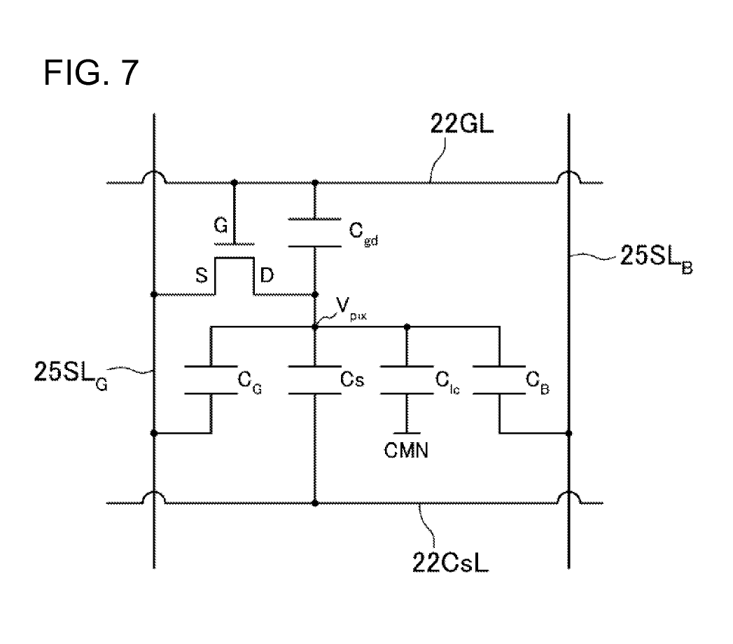

The size of potential change ΔV_{pixG} of the pixel electrode 27_{G} due to change in potential in the source signal line 25SL_{G} is shown in formula 3 below (refer to FIG. 7).

$$\begin{matrix}〈 Formula 3 〉 & \\ Δ {V}_{pixG} = Δ {V}_{g} \times \frac{{C}_{G}}{{C}_{gd} + {Cs}_{G} + {C}_{lc} + {C}_{G} + {C}_{B}} & ( 3 )\end{matrix}$$

Because the source signal line 25SL_{G} and the pixel electrode 27_{G} do not overlap, in formula 3, C_{G} can be made approximately 0. Therefore, the size of potential change ΔV_{pixG} of the pixel electrode 27_{G} due to the change in potential in the source signal line 25SL_{G} is approximately 0.

Also, because the source signal line 25SL_{B} and the pixel electrode 27_{G} do not overlap, in formula 4, C_{B} can be made approximately 0. Therefore, the size of potential change ΔV_{pixG} of the pixel electrode 27_{G} due to the change in potential in the source signal line 25SL_{B} is approximately 0.

$$\begin{matrix}〈 Formula 4 〉 & \\ Δ {V}_{pixG} = Δ {V}_{B} \times \frac{{C}_{B}}{{C}_{gd} + {Cs}_{G} + {C}_{lc} + {C}_{G} + {C}_{B}} & ( 4 )\end{matrix}$$

Based on this, it is possible to keep the size of potential change ΔV_{pixG} in the pixel electrode 27_{G} of the green pixel at a small value, thus mitigating the occurrence of flickering in the green pixel.

Also, in the color liquid crystal display device of the configuration of Embodiment 1, the distance W_{G} between the two source signal lines 25SL_{G} and 25SL_{B} of the green pixel is set to be greater than the distance W_{R} between the two source signal lines 25SL_{R} and 25SL_{G} of the red pixel, and the distance W_{B} between the two source signal lines 25SL_{B} and 25SL_{R} of the blue pixel, and thus, the storage capacitance Cs_{G} of the green pixel is greater than that of the red pixel and the blue pixel. Therefore, the denominators on the right side of formulae 3 and 4 become greater and the size of potential change ΔV_{pixG} of the pixel electrode 27_{G} becomes smaller. As a result, flickering in the green pixel is mitigated.

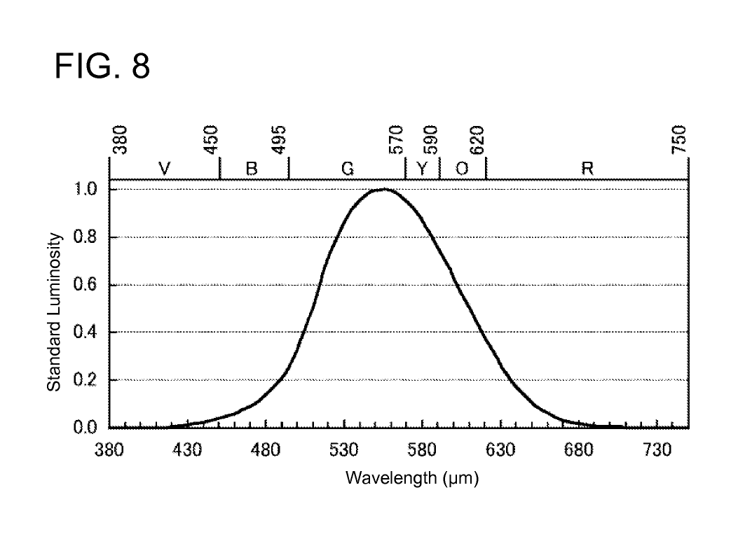

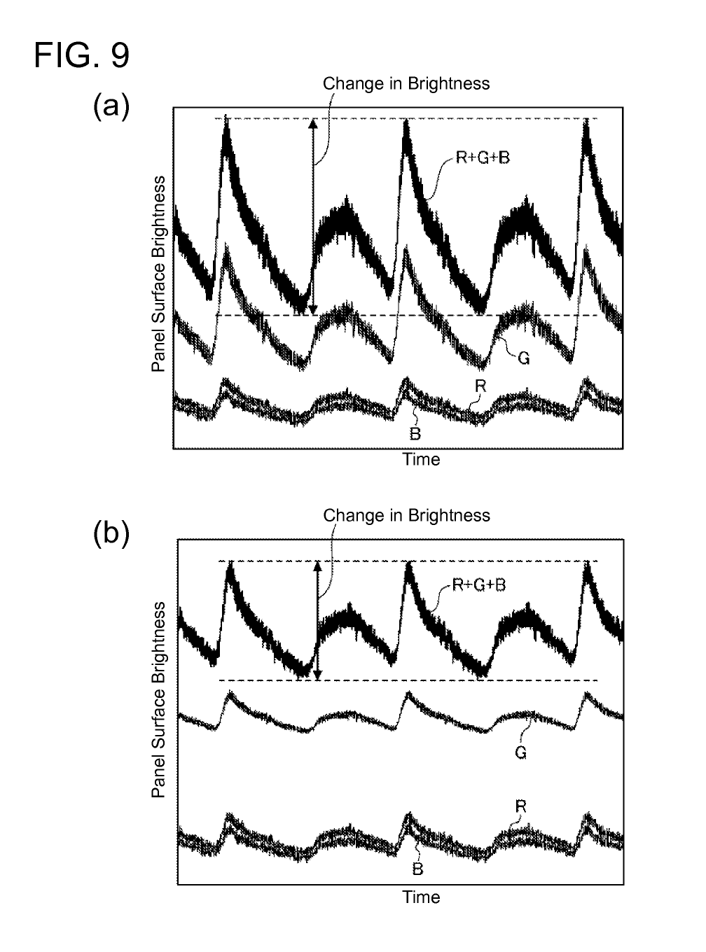

Green is known to have a higher standard luminosity than red or blue (refer to the standard luminosity curve in FIG. 8). As a result, changes in brightness are more easily detected in green pixels than in other pixels (in other words, flickering in the green pixels is more easily detected by users viewing the panel than the same amount of flickering in red pixels or blue pixels), and are a cause for display anomalies due to flickering in the panel as a whole (refer to FIG. 9(a)). In the color liquid crystal display device of Embodiment 1, as described above, flickering in the green pixels can be mitigated, and thus, the user does not detect flickering as easily when viewing the panel, and as a result, an excellent display quality can be attained for the color liquid crystal display device as a whole (refer to FIG. 9(b)).

Also, in the color liquid crystal display device 10, even if pixel data rewriting is conducted at a low frequency of 45 Hz or less in order to reduce power consumption, the user does not easily detect flickering, and thus, an excellent display quality can be attained. In particular, even when displaying still images in a display of an electronic book, the user can view the image without experiencing stress due to flickering.

### (Modification Example)

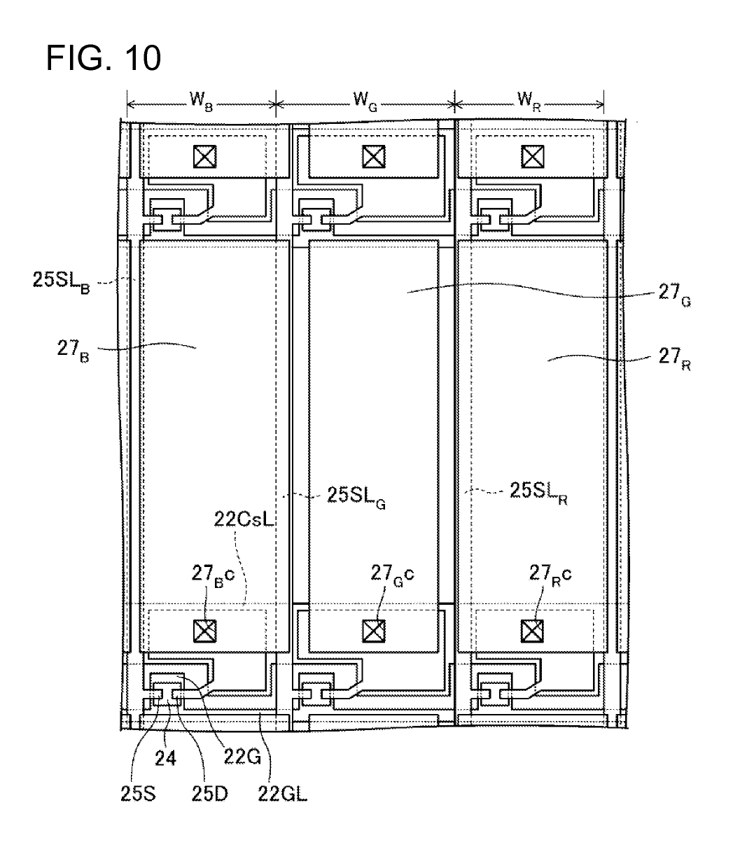

Embodiment 1 describes a configuration in which the pixel electrode 27_{R} of the red pixel is formed above the source signal line 25SL_{G} of the green pixel so as to overlap therewith, but as shown in FIG. 10 as Modification Example 1, the pixel electrode 27_{B} of the blue pixel may be formed on the source signal line 25SL_{G} of the green pixel so as to overlap therewith.

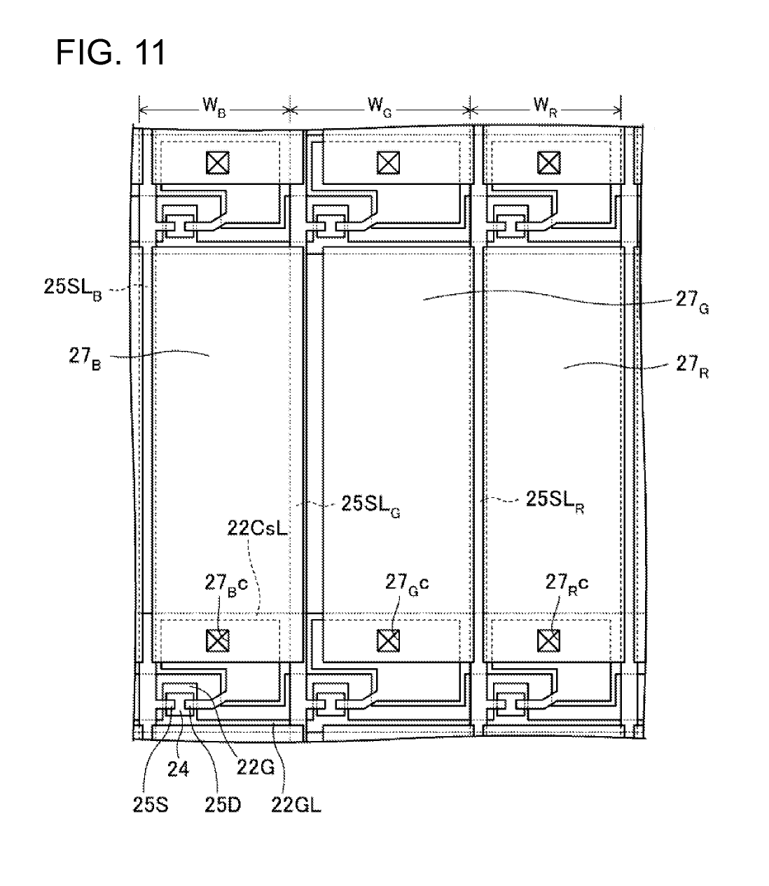

Also, in Embodiment 1, a configuration was described in which the pixel electrode 27_{G} of the green pixel is provided so as not to overlap with the two source signal lines 25SL_{G} and 25SL_{B} of the green pixel, but as shown in FIG. 11 as Modification Example 2, for example, the pixel electrode 27_{G} of the green pixel may be disposed such that a portion thereof overlaps with the source signal line 25SL_{B} of the blue pixel. In this case, parasitic capacitance is generated between the pixel electrode 27_{G} and the source signal line 25SL_{B}, and the change in potential in the source signal line 25SL_{B} of the blue pixel causes a change in potential in the pixel electrode 27_{G} of the green pixel, and thus, compared to Embodiment 1, the effect of mitigating flickering in the green pixel is lessened. However, the sum of the parasitic capacitances generated between the pixel electrode 27_{G} of the green pixel and the respective two source signal lines 25SL_{G} and 25SL_{B} of the green pixel is less than that of the red pixel and the blue pixel, and thus, flickering in the green pixel can be mitigated, thus making it more difficult for the user to detect flickering in the panel, and an excellent display quality can be attained in the color liquid crystal display device 10 as a whole.

### Embodiment 2

Next, a color liquid crystal display device 10 according to Embodiment 2 will be described.

### (Color Liquid Crystal Display Device)

The color liquid crystal display device 10, similar to Embodiment 1, is constituted of a liquid crystal display panel in which a TFT substrate 20 and an opposite substrate 30 are disposed opposite to each other, and a backlight.

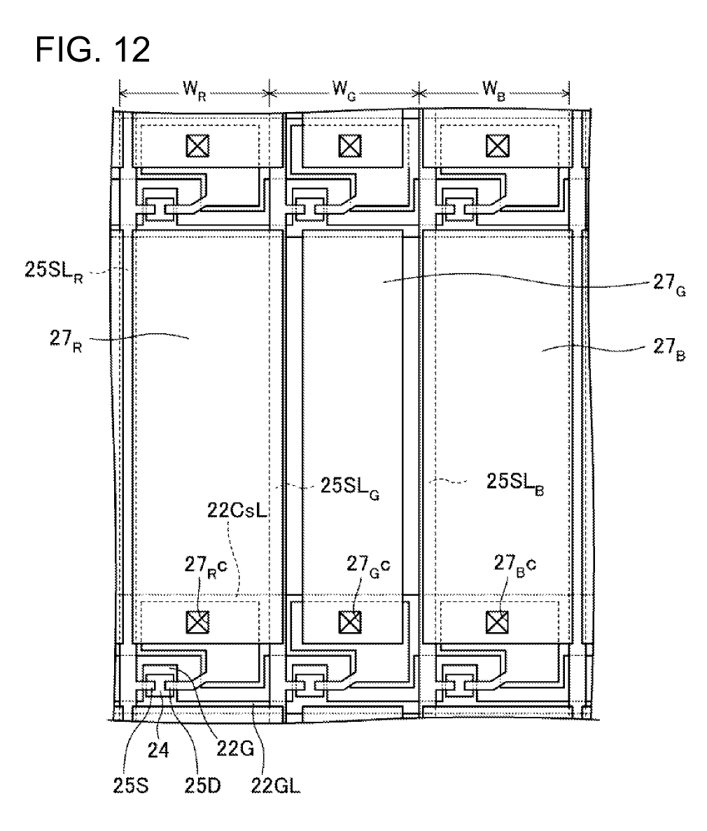

FIG. 12 is a plan view of the TFT substrate 20.

The TFT substrate 20 has a configuration in which various signal lines and the like including gate signal lines 22GL, a gate insulating film 23, a semiconductor film 24, various signal lines and the like including source signal lines 25SL_{R}, 25SL_{G}, and 25SL_{B}, an overcoat film 26a and a planarizing film 26b, which constitute the interlayer insulating film, pixel electrodes 27_{R}, 27_{G}, and 27_{B}, and an alignment film 28 are layered in this order on a main substrate body 21.

As shown in FIG. 12, the source signal lines 25SL_{R}, 25SL_{G}, and 25SL_{B} are disposed such that a distance W_{R} between the source signal lines 25SL_{R} and 25SL_{G}, a distance W_{G} between the source signal lines 25SL_{G} and 25SL_{B}, and a distance W_{B} between the source signal lines 25SL_{B} and 25SL_{R} are equal. With this configuration, the storage capacitances Cs_{G}, Cs_{R}, and Cs_{B} are the same in the green pixel, the red pixel, and the blue pixel.

Other configurations of the TFT substrate 20 are the same as those of Embodiment 1.

Configurations of the opposite substrate 30, the sealing member 40, and the liquid crystal layer 50 are the same as those of Embodiment 1, and therefore, descriptions thereof are omitted.

### (Manufacturing Method for Color Liquid Crystal Display Device)

The liquid crystal display device of Embodiment 2, as in Embodiment 1, can be manufactured using a conventional and well-known manufacturing method.

### (Effects of Embodiment 2)

In the color liquid crystal display device configured as in Embodiment 2, in the green pixel, the respective two source signal lines 25SL_{G} and 25SL_{B} of the green pixel, and the pixel electrode 27_{G} of the green pixel are disposed so as not to overlap from a plan view, and thus parasitic capacitance is not generated between the source signal line 25SL_{G} or 25SL_{B}, and the pixel electrode 27_{G}.

As a result, similar to Embodiment 1, it is possible to keep the size of potential change ΔVₚᵢₓ in the pixel electrode 27_{G} of the green pixel at a low level, thereby mitigating the occurrence of flickering in the green pixel, which has the highest luminosity. Therefore, users who view the panel will not detect as much flickering, and as a result, it is possible to attain excellent display quality for the entire color liquid crystal display device.

Also, in the color liquid crystal display device of Embodiment 2, the source signal lines 25SL_{R}, 25SL_{G}, and 25SL_{B} are disposed such that the distances therebetween W_{R}, W_{G}, and W_{B} are equal, and thus, the source signal lines can be formed uniformly without needing to change the layout for different color pixels.

### Embodiment 3

Next, a color liquid crystal display device 10 according to Embodiment 3 will be described.

### (Color Liquid Crystal Display Device)

The color liquid crystal display device 10, similar to Embodiment 1, is constituted of a liquid crystal display panel in which a TFT substrate 20 and an opposite substrate 30 are disposed opposite to each other, and a backlight.

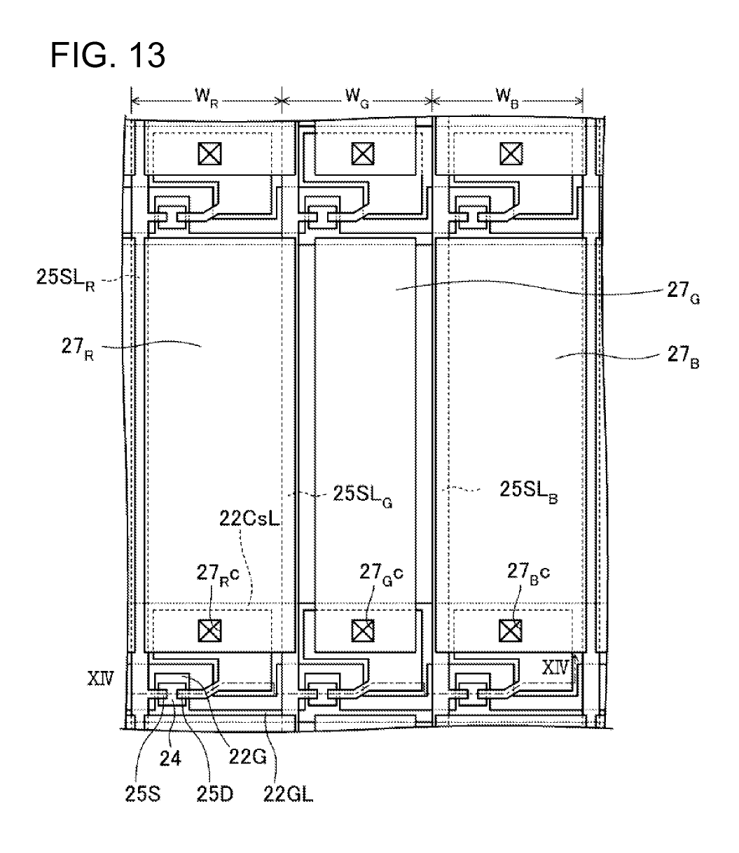

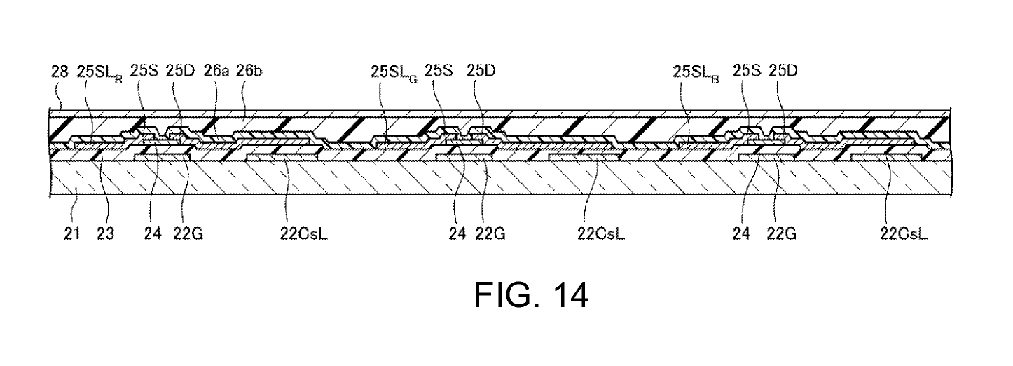

FIG. 13 is a plan view of the TFT substrate 20. FIG. 14 is a cross-sectional view of FIG. 3 along the line XIV-XIV.

The TFT substrate 20 has a configuration in which various wiring lines and the like including gate signal lines 22GL, a gate insulating film 23, a semiconductor film 24, various wiring lines and the like including source signal lines 25SL_{R}, 25SL_{G}, and 25SL_{B}, an overcoat film 26a and a planarizing film 26b, which constitute an interlayer insulating film, pixel electrodes 27_{R}, 27_{G}, and 27_{B}, and an alignment film 28 are layered in this order on a main substrate body 21.

As shown in FIG. 13, the source signal lines 25SL_{R}, 25SL_{G}, and 25SL_{B} are disposed such that a distance W_{R} between the source signal lines 25SL_{R} and 25SL_{G}, a distance W_{G} between the source signal lines 25SL_{G} and 25SL_{B}, and a distance W_{B} between the source signal lines 25SL_{B} and 25SL_{R} are equal. On the other hand, as shown in FIG. 14, the gate insulating film 23 that covers the storage capacitance wiring lines 22CsL is formed to be thinner in the green pixel than in the red pixel and the blue pixel. Specifically, the thickness of the gate insulating film 23 in the storage capacitance part of the green pixel is approximately 50 to 450 nm when using a silicon dioxide film, for example, and the thickness of the gate insulating film 23 of the storage capacitance part in the red pixel and blue pixel is approximately 100 to 500 nm when using a silicon dioxide film, for example. By making the gate insulating film 23 between the storage capacitance wiring line 22CsL and the drain electrode 25D thinner in the green pixel than in other pixels, the storage capacitance Cs_{G} generated in the green pixel can be set larger than the storage capacitances Cs_{R} and Cs_{B} of the red pixel and the blue pixel.

Other configurations of the TFT substrate 20 are the same as those of Embodiment 1.

Configurations of the opposite substrate 30, the sealing member 40, and the liquid crystal layer 50 are the same as those of Embodiment 1, and therefore, descriptions thereof are omitted.

### (Manufacturing Method for Color Liquid Crystal Display Device)

The liquid crystal display device of Embodiment 3 can be manufactured using a manufacturing method similar to Embodiment 1, except that when forming the gate insulating film 23, a step of thinning the gate insulating film 23 at the storage capacitance part in the green pixel is necessary. An example of a method for forming the gate insulating film 23 in the storage capacitance part so as to be thinner for the green pixel than for other pixels includes a method in which, after forming the insulating film on the entire surface, regions corresponding to the green pixels are etched, for example.

### (Effects of Embodiment 3)

In the color liquid crystal display device configured as in Embodiment 3, in the green pixel, the respective two source signal lines 25SL_{G} and 25SL_{B} of the green pixel are disposed so as not to overlap with the pixel electrode 27_{G} of the green pixel from a plan view, and thus, parasitic capacitance is not generated between the source signal line 25SL_{G} or 25SL_{B} and the pixel electrode 27_{G}. Therefore, the size of potential change ΔVₚᵢₓ of the pixel electrode 27_{G} is small.

In the color liquid crystal display device configured as in Embodiment 3, the gate insulating film 23 that covers the storage capacitance wiring line 22CsL disposed in the green pixel is thinner than in the red pixel and the blue pixel, and thus, the storage capacitance Cs_{G} of the green pixel is greater than that of the red pixel and the blue pixel. Therefore, the size of potential change ΔVₚᵢₓ of the pixel electrode 27_{G} is small.

Based on this, similar to Embodiment 1, by keeping the size of potential change ΔVₚᵢₓ in the pixel electrode 27_{G} of the green pixel small, the occurrence of flickering in the green pixel, which has the highest luminosity, is mitigated. Therefore, users who view the panel will not detect as much flickering, and as a result, it is possible to attain excellent display quality for the entire color liquid crystal display device.

Also, in the color liquid crystal display device of Embodiment 3, the source signal lines 25SL_{R}, 25SL_{G}, and 25SL_{B} are disposed such that the distances therebetween W_{R}, W_{G}, and W_{B} are equal, and thus, the source signal lines can be formed uniformly without needing to change the layout for different color pixels.

### Other Embodiments

Embodiments 1 to 3 describe a liquid crystal display device that displays RGB color and is constituted of a plurality of pixels of the three colors of red, green, and blue, but the liquid crystal display device may display color with four pixel colors, for example. Examples of displaying color with four colors of pixels include an RGBY color display constituted of a plurality of pixels of red, green, blue, and yellow, or an RGBW color display constituted of a plurality of pixels of red, green, blue, and white, for example.

A case in which the color liquid crystal display device conducts RGBY color display will be described. As shown in the standard luminosity curve in FIG. 7, among red, green, blue, and yellow, the color with the highest standard luminosity is green, followed by yellow, and red and blue have the lowest standard luminosity. Therefore, in this case, in the green pixel, a pixel electrode and two source signal lines of the green pixel are disposed so as not to overlap, such that parasitic capacitance is not generated therebetween.

It is preferable that in the yellow pixel, which has the second highest standard luminosity, a pixel electrode of the yellow pixel and two source signal lines of the yellow pixel do not overlap, or that the area of overlap be smaller than in the red pixel and the blue pixel. As a result, parasitic capacitance is not generated therebetween, or the generated parasitic capacitance is less than that of the red pixel and the blue pixel.

In addition to minimizing the size of potential change in the pixel electrode of the green pixel, which has the highest luminosity, the size of potential change in the yellow pixel, which has the second highest luminosity, is also minimized, and thus, the user does not easily detect flickering in the panel. As a result, an excellent display quality can be attained in the color liquid crystal display device as a whole.

Next, a case in which the color liquid crystal display device conducts RGBW color display will be described. In the standard luminosity curve of FIG. 7, the standard luminosity for white is not shown, but since white can be understood as being an integral of a plurality of colors, among red, green, blue, and white, the color with the highest luminosity is white, and flickering in the white pixel can be easily detected by a user. Therefore, in this case, in the white pixel, a pixel electrode and two source signal lines of the white pixel are disposed so as not to overlap, such that parasitic capacitance is not generated therebetween.

In the green pixel, which has the second highest luminosity, it is preferable that a pixel electrode of the green pixel also be disposed so as not to overlap with two source signal lines of the green pixel, or that the area of overlap be smaller than in the red pixel and the blue pixel. As a result, parasitic capacitance is not generated therebetween, or the generated parasitic capacitance is less than that of the red pixel and the blue pixel.

In addition to minimizing the size of potential change in the pixel electrode of the white pixel, which has the highest luminosity, the size of potential change in the green pixel, which has the second highest luminosity, is also minimized, and thus, the user does not easily detect flickering in the panel. As a result, an excellent display quality is attained for the color liquid crystal display device as a whole.

Embodiments 1 to 3 describe the fact that in the liquid crystal display device 10 that conducts RGB color display, the pixel electrode 27_{G} of the green pixel does not overlap with the source signal lines 25SL_{G} and 25SL_{B} (or the area of overlap is less than that of the red pixel and the blue pixel) and does not describe the size relation of the overlap between the pixel electrode 27 and the source signal lines SL in the red pixel and the blue pixel, but the size of overlap in the respective red pixel and blue pixel may be the same or different.

### INDUSTRIAL APPLICABILITY

The present invention is applicable as a color liquid crystal display device, and in particular is applicable to a low power consumption color liquid crystal display device in which a panel that can be driven at low frequency is used and in which the occurrence of flickering display brightness is mitigated.

### DESCRIPTION OF REFERENCE CHARACTERS

10 color liquid crystal display device

11 display region

20 TFT substrate (active matrix substrate)

22CsL storage capacitance wiring line

22GL gate signal line

23 gate insulating film

25SL_{R}, 25SL_{G}, 25SL_{B}, 25SL source signal line

26a overcoat film (interlayer insulating film)

26b planarizing film (interlayer insulating film)

27_{R}, 27_{G}, 27_{B}, 27 pixel electrode

30 opposite substrate

32_{R}, 32_{G}, 32_{B}, 32 color filter

33 black matrix

50 liquid crystal layer

1. A color liquid crystal display device, comprising an active matrix substrate and an opposite substrate disposed opposite to each other with a liquid crystal layer therebetween,
wherein the active matrix substrate includes:
a plurality of gate signal lines that extend parallel to each other in a display region;
a plurality of storage capacitance wiring lines provided in a same layer as the gate signal lines and between the gate signal lines, extending parallel to the gate signal lines and to each other;
a gate insulating film provided so as to cover the plurality of gate signal lines and the plurality of storage capacitance wiring lines;
a plurality of source signal lines provided in a layer above the gate insulating film and intersecting orthogonally with the plurality of gate signal lines while extending parallel to each other;
an interlayer insulating film provided so as to cover the source signal lines;
a plurality of pixels each formed in a region bordered by the plurality of gate signal lines and source signal lines;
a plurality of switching elements provided so as to respectively correspond to the plurality of pixels and provided for respective intersections of the plurality of gate signal lines and source signal lines; and
a plurality of pixel electrodes provided in a layer above the interlayer insulating film respectively corresponding to the plurality of pixels,
wherein the plurality of pixels include at least a first color pixel that conducts display in a first color, a second color pixel that conducts display in a second color having a lower standard luminosity than the first color, and a third color pixel that conducts display in a third color having a lower standard luminosity than the first color, and
wherein a sum of parasitic capacitances formed between the pixel electrode and respective two source signal lines of the corresponding pixel is less in the first color pixel than in other pixels.

2. The color liquid crystal display device according to claim 1,
wherein a storage capacitance formed between a storage capacitance wiring line disposed in each of the first to third color pixels and a pixel electrode corresponding to said pixel is set greater in the first color pixel than in other pixels.

3. The color liquid crystal display device according to claim 1,
wherein the first color pixel is a green pixel that conducts display in green, the second color pixel is a red pixel that conducts display in red, and the third color pixel is a blue pixel that conducts display in blue.

4. The color liquid crystal display device according to claim 3,
wherein in the green pixel, the respective two source signal lines of the green pixel do not overlap with the pixel electrode corresponding to said green pixel from a plan view.

5. The color liquid crystal display device according to claim 3,
wherein a pixel electrode corresponding to the red pixel overlaps with a source signal line that supplies a source signal to a switching element corresponding to the green pixel from a plan view.

6. The color liquid crystal display device according to claim 3,
wherein a pixel electrode corresponding to the blue pixel overlaps with a source signal line that supplies a source signal to a switching element corresponding to the green pixel from a plan view.

7. The color liquid crystal display device according to claim 3,
wherein a distance between the two source signal lines of the green pixel is greater than in other pixels such that a storage capacitance formed between a storage capacitance wiring line disposed in each of the plurality of pixels and a pixel electrode corresponding to said pixel is set to be greater in the green pixel than in other pixels.

8. The color liquid crystal display device according to claim 3,
wherein the gate insulating film is thinner in a region of the green pixel than in other pixel regions such that a storage capacitance formed between a storage capacitance wiring line disposed in each of the plurality of pixels and a pixel electrode corresponding to said pixel is set to be greater in the green pixel than in other pixels.

9. The color liquid crystal display device according to claim 1,
wherein on the opposite substrate, a plurality of color filters are provided so as to respectively correspond to the plurality of pixels, and a black matrix is provided corresponding to regions bordering said plurality of pixels so as to border said plurality of color filters.

10. The color liquid crystal display device according to claim 1,
wherein the plurality of pixels further include a fourth color pixel that conducts display in a fourth color with a lower standard luminosity than the first color, in addition to the first to third color pixels.

11. The color liquid crystal display device according to claim 10,
wherein the first color is green, the second color is red, the third color is blue, and the fourth color is yellow.

12. The color liquid crystal display device according to claim 1,
wherein pixel data rewriting is conducted at a low frequency of 45 Hz or less.

13. The color liquid crystal display device according to claim 1,
wherein the color liquid crystal display device is a display of an electronic book.

14. The color liquid crystal display device according to claim 1,
wherein each of the plurality of switching elements includes a semiconductor film made of an oxide semiconductor.

15. The color liquid crystal display device according to claim 14,
wherein the oxide semiconductor is indium gallium zinc oxide.
